(19) United States
(12) Patent Application Publication
(10) Pub. No.: US 2010/0185896 A1
(43) Pub. Date: Jul. 22, 2010

(54) METHOD AND APPARATUS FOR FULLY REDUNDANT CONTROL OF LOW-SPEED PERIPHERALS

(75) Inventors: Michael Andres, Holzgerlingen (DE); Giovanni Cautillo, Stuttgart (DE); Thomas Hess, Bad Liebenzell (DE); Markus Strasser, Metzingen (DE)

Correspondence Address: Dan Salehi;The Salehi Law Group, 8 Crystalglen Street, Aliso Viejo, CA, 92656, US

(73) Assignee: INTERNATIONAL BUSINESS MACHINES CORPORATION, Armonk, NY (US)

(21) Appl. No.: 12/358,156

(22) Filed: Jan. 22, 2009

(51) Int. Cl. G06F 11/30; G06F 11/20

(52) U.S. Cl. 714/5; 714/E11.179; 714/E11.071

(57) ABSTRACT

The invention, in an embodiment, allows the control of several hardware ports via two redundant I2C paths. Switching between the two I2C paths is achieved by using a redundant control device, which performs the switch by tracking if incoming data transfers were completed with I2C stop condition.

### BACKGROUND

1. Field of the Invention

The present invention provides a method and apparatus for fully redundant control of low-speed peripherals, and in particular, two redundant inter-integrated circuit paths for controlling several hardware ports.

2. Description of Related Art

The concept of a service processor is well known in the field of data processing systems and particularly server class systems. Service processors are provided to manage certain aspects of a server and can be defined loosely as an auxiliary processor that monitors the environment and health of one or more main processors and their associated subsystems. In the event of an actual or predicted problem with a main processor, subsystem, or the environment, the service processor is capable of taking action to alert a system administrator and/or to correct the problem on its own. Service processors have been used on large systems such as IBM mainframes for decades and are now well established as a management tool for industry standard class servers.

Redundant service processors may be provided in high-availability systems so that a failure of one service processor does not result in the loss of the monitoring, alerting, and initialization capabilities that are imperative in such systems. Implementing redundant service processors is complicated for a number of reasons. A method by which the service processors agree which one is in control must be defined and subscribed to by both service processors. All subsystems, including the service processors themselves, must understand which service processor is in control at any given point in time. In some instances, hardware must be provided to switch buses from one service processor to the other and this hardware must switch the buses synchronously with fail-over of control from one service processor to the other. For purpose of this disclosure “fail-over” refers to a transfer of control from one service processor to another.

There are a number of conventional methods used in the industry to provide fail-over of redundant subsystems and to coordinate the actions of redundant controllers. For example, in a prior art dotted I2C bus, where the I2C bus is dotted before a connection to a I2C port expander, if one control unit has no power, the other control unit is not able to access the port expander as the I2C lines become pulled down to low. Also, a short between the I2C wires can also occur, causing a similar problem.

Another prior art example is a redundant port expander, where a low-speed peripheral such as a light-emitting diode (LED), is dotted after the I2C port expander. In this system, if one of the I2C buses has a short or opening, the LED lightstrip becomes uncontrollable. Furthermore, the LED blink support has to be done in firmware which runs on the two separate control units. Thus, no I2C port expander with built-in blink support can be used.

Yet another prior art example is a redundant microcontroller, where a multiplexer controlled by two separate microcontrollers is used. A disadvantage of this system is that it may require complex firmware in the control units and microcontrollers. The firmware running on the control unit which is the “master” has to write the data to both microcontrollers and has to decide which of the two microcontrollers actually controls the LED. Furthermore, after a failure in the path, the firmware on the control unit has to resynchronize with both of the microcontrollers. In addition, the register settings of the slave control unit is not readable by the master control unit, and vice-versa.

Therefore, there is a need for a method and apparatus that enables the use of several hardware ports via two redundant I2C buses which do not exhibit the aforementioned disadvantages.

### SUMMARY

The invention, in an embodiment, allows the control of several hardware ports via two redundant I2C paths. Switching between the two I2C paths is achieved by using a redundant control device, which performs the switch by tracking if incoming data transfers were completed with I2C stop condition. In a preferred embodiment, a lightstrip is used as the low-speed peripheral for a system repair or upgrade scenario where the different ports each control a dedicated LED on a lightstrip. By having redundant I2C paths and two redundant controllers, the blinking of an LED is maintained even in the event of a fault at one of the controllers.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a diagram illustrating a light strip using I2C redundant control;

FIG. 2 is a circuit diagram of a light strip using I2C redundant control;

FIG. 3 is a diagram illustrating a hardware implementation for using redundant I2C buses for port control;

FIG. 4 is a flowchart illustrating a write mode during port control; and

FIG. 5 is a diagram illustrating the differences between an embodiment of the present invention and a conventional I2C bus switch.

### DETAILED DESCRIPTION

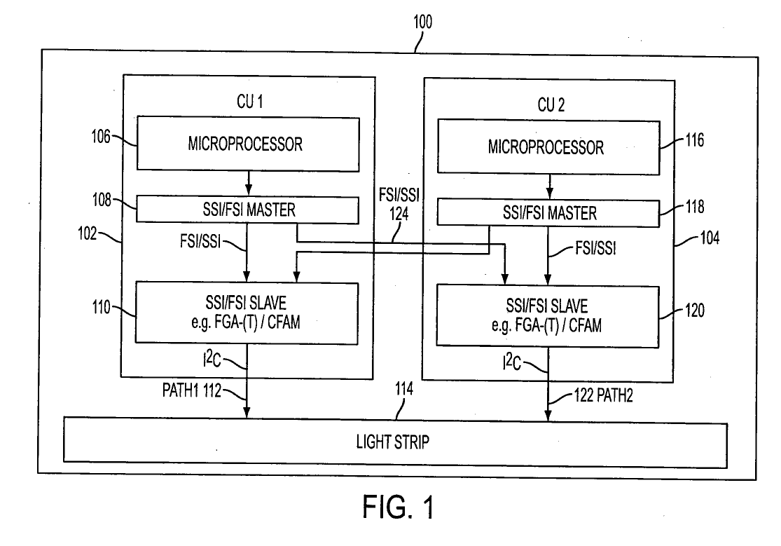

FIG. 1 is a diagram illustrating a light strip using I2C redundant control. The redundant light strip control 100 consists of control unit 102 and control unit 104, which are used to control the light strip 114. The redundant light strip control 100 structure allows either control unit 102 or control unit 104 to control access to the light strip 114. Furthermore, control unit 102 can access the light strip 114 via its I2C bus 112, or control unit 102 can access the light strip 114 via the I2C bus 122 corresponding to control unit 104. Thus, in an embodiment of this invention, both control units can use both I2C buses. The microcontroller 202 is used to switch the LED on and off, to produce a “blinking” effect.

In an embodiment, the light strip 114 is used to show a user, such as a systems engineer, on what location a field replaceable unit (FRU) should be replaced or added while a repair or upgrade is occurring. An LED (not shown) on the light strip 114 corresponding to a particular FRU blinks or is activated to indicate a required or suggested service.

The term “redundant” is used to describe the two I2C bus paths, path 112, and path 122, which can be used to control the light strip 114. Thus, the present invention does not require the light strip 114 itself to have built-in redundant components. The redundant I2C buses are used since in many cases, the cables and connectors used in buses and paths are prone to error and failure. The failure of one bus does not compromise the integrity of the system as the redundant bus is activated in the event of a failure.

The advantage of allowing both control units to use both I2C buses is that it allows, for example, control unit 102 to be a master controller, while control unit 104 remains a slave controller. While control unit 102 is in master mode, control unit 104 is in standby mode. In case of a failure on control unit 102, control unit 104 becomes the master controller and assumes control of the light strip 114. When this occurs, control unit 102 is rebooted, and is placed in standby mode, and is now the slave controller.

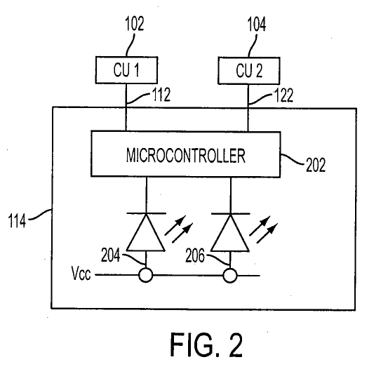

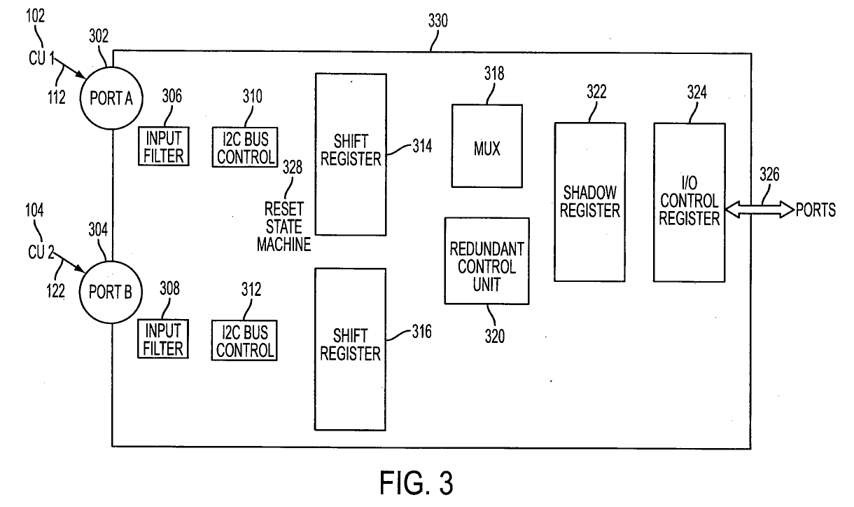

FIG. 2 is a circuit diagram of a light strip using I2C redundant control. The present invention can be implemented in firmware using a microcontroller 202, or alternatively, directly in a special hardware configuration (See FIG. 3). I2C bus 112 and I2C bus 122 are each connected to different pints on the microcontroller 202, which in turn provide access to LED 204 and LED 206 respectively, to control the lightstrip 114. The microcontroller 202 does the dotting, instead of having a dotted I2C bus.

The present invention allows each LED to be controlled from each I2C bus without any restriction. For example, in an embodiment, if LED 204 is switched on using I2C bus 112, it can subsequently be switched off using I2C bus 122. Furthermore, the microcontroller 202 controls blinking of each LED. Thus, no further activity is required by control unit 102 or control unit 104 after a start LED blinking command. In the case of blinking LEDs, in conventional systems, the control unit has to continuously switch the LED on and off using firmware, which decreases the processor performance of the control unit. The present invention eliminates this performance drain as the microcontroller 202 controls the blinking as described above. The microcontroller 202 is used to switch the LED on and off, to produce a “blinking” effect.

The present invention also reduces the complexity of the required firmware, as no resynchronization is needed between control unit 102 and control unit 104. As described above, the system monitors the master control for a failure, and if a master control unit fails, the slave control unit becomes the master control unit upon failure. In addition, having a single microcontroller 202 with redundant I2C buses allows storing of operation conditions and parameters in a non-volatile memory (not shown).

In another embodiment, the microcontroller 202 can located remote from the lightstrip 114. In this embodiment, a chip which contains the implementation (as shown in FIG. 3 below) may be used.

Additionally, multiple control units (e.g., LEDs) can be utilized, and the present invention is not limited to two control units.

FIG. 3 is a diagram illustrating a hardware implementation for using redundant I2C buses for port control. The I2C bus 112 from control unit 102 is connected to the pins of port 302, while the I2C bus 122 from control unit 104 is connected to the pins of port 304. In an embodiment, an input filter 306 is used for noise reduction. However, any know input filters or noise reduction methods may be utilized for noise reduction. The I2C bus control 310 and I2C bus control 312 contains the state machine logic which controls the I2C traffic on I2C bus 112 and I2C bus 122, respectively. A reset state machine function 328 is used for recovery purposes, and allows the I2C bus control 310 or 312 to reset one of the I2C ports.

Upon failure of the master control, control unit 104 becomes the master control, and control unit 102 is reset, and become the slave control. Control unit 104 is then continuously monitored for a failure.

Shift register 314 and shift register 316 convert the serial I2C data bits into 8-bit data bytes. The shift registers also convert 8-bit data bytes into serial I2C data bits. The multiplexer 318 is used to select one of the shift registers, shift register 314 or shift register 316. In an embodiment, the multiplexer 318 is controlled from the redundant control unit 320.

The redundant control unit 320 selects the appropriate data source, shift register 314 or shift register 316, using the multiplexer 318. The redundant control unit 320 is also responsible for tracking the start offset of received bytes, and for counting the number of received bytes. It also copies the shadow register 322 to the I/O control register 324 after an I2C stop condition has been received. In an embodiment, only the number of received bytes beginning at the start offset are copied. In the scenario where the end of the shadow register 322 has been reached but all of the incoming bytes have not yet been received, the offset wraps to zero. The I2C read operation provides data from the I/O control register 324 each time a data byte is requested from either of the ports, port 302 or port 304.

In an embodiment, the shadow register 322 has the same register size as the I/O control register 324. Each received data byte on the I2C ports is first stored in the shadow register 322. The I/O control register 324 provides functionality such as the blink control register, duty cycle register, frequency register, or any other low-speed peripheral functionality that can be controlled. The ports 326 are the pins controlled from the I/O control register 324.

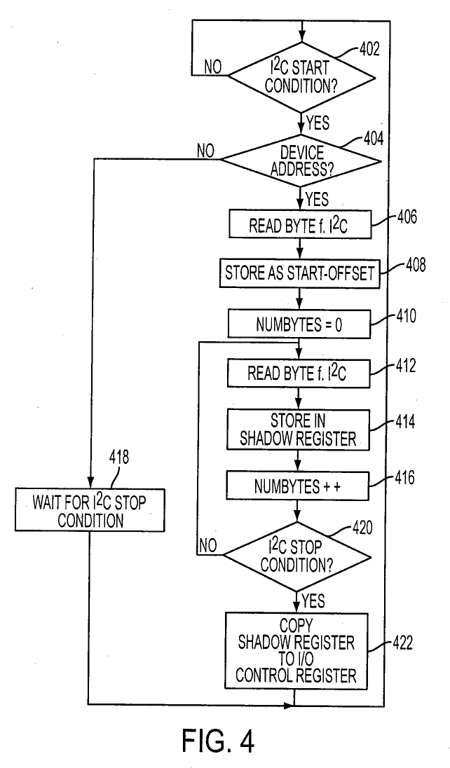

FIG. 4 is a flowchart illustrating a write mode during port control. In step 402, the I2C state machine receives a start condition with a matching I2C device address on a I2C port. In an embodiment, the I2C state machine idly waits until a start condition is detected on the I2C bus. In step 404, the data address of the data byte is checked to determine if it matches with the slave device address. If there is not a match, the process continues to step 418, where the I2C state machine continues to wait for an I2C stop condition.

If there is a match, then an I2C bit acknowledge is performed, and the process continues to step 406, where the byte is read from the I2C bus and stored as an offset in step 408. The I2C bus control requests the multiplexer, as described above, to reset the I2C state machine of the other I2C bus control. Resetting the other I2C state machine of the other I2C bus control brings the other I2C bus control into a defined state, such as standby mode, in case a previous data transfer on the port was terminated unsuccessfully without sending a stop condition. If the other I2C bus control is still active due to a data transfer, the data transfer will be canceled and the data in the stage register will not be copied.

In step 410, the counter counting received bytes from the I2C bus is cleared and reset to zero. In another embodiment, the counter may be reset to any pre-determined value. In step 412, the byte is read from the I2C bus again and then stored in the shadow register based on the offset calculated in the previous step. The storage position is calculated based on the sum of the start of the offset (StartOffset) plus the number of bytes (NumBytes) modulo with the total register size (TotalSize). For example, the algorithm used is: (StartOffset+NumBytes) MOD TotalSize. An I2C bit acknowledge is then performed.

In step 416, the counter is incremented for each received byte until an I2C stop condition is received at step 420. A stop condition is a standard I2C sequence on SDA and SCL lines indicating the end of t of transmission. If a stop condition is not received, the process continues back to step 412 where the bytes continue to be read from the I2C bus. However, if a stop condition is received, the process continues to step 422 where the count of received bytes is copied from the shadow register starting on offset to the I/O control register starting on offset.

On the other hand, to read data from the I/O control register, the start offset has to be set first using the I2C write mode described above. This is followed by a repeated start condition, and then a read operation as defined by the I2C standard. After receiving a start condition with a matching I2C device address of an I2C port, the I2C bus control selects the multiplexer and resets the I2C state machine of the other I2C bus control. Resetting the other I2C state machine of the other I2C bus control brings the other I2C bus control into a defined state, such as standby mode, in case a previous data transfer on the port was terminated unsuccessfully without sending a stop condition. If the other I2C bus control is still active due to a data transfer, the data transfer will be cancelled and the data in the stage register will not be copied.

As in the write mode, the next received data byte is used as a start offset to address the shadow register. To switch to the read more, a repeated start condition has to be sent with the device address and the read bit. Each requested data byte from the control unit working as an I2C master will be read directly from the I/O control register. If the end of the I/O control register has been received, the offset wraps to zero. The read will be terminated by the control unit sending an not acknowledgment (NAK) followed by a stop condition.

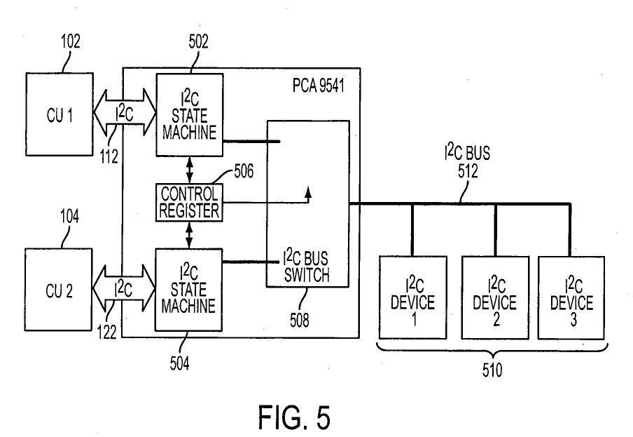

FIG. 5 is a diagram illustrating the differences between an embodiment of the present invention and a conventional I2C bus switch. I2C state machine 502, connected to control unit 102 via I2C bus 112, and I2C state machine 504, connected to control unit 104 via I2C bus 122, control various I2C devices 510. In an embodiment, the I2C devices are low-speed peripheral devices, such as, for example, LEDs, relays, switches, speakers, displays, disk drives, and signal transmitters and receivers.

In conventional systems, an I2C bus switch 508 is used, such as, for example, an NXP Bus Master Selector (PCA 9541) that is controlled using firmware from the control unit firmware using the control register 506 and used to send signals to the I2C devices 510 via an I2C bus 512. In the present invention, I2C bus switch 508 is controlled by an automatic mechanism The multiplexer is automatically switched, as in conventional systems.

Thus, the switch between the two I2C bus paths is achieved using the redundant control of the control register 506, which tracks if data transfer were completed with an I2C stop condition. The control register 506 effectively performs the switching between I2C bus paths, and allows control of several hardware ports via the two redundant I2C bus paths.

In another embodiment, the present invention may be used with more than two I2C bus ports, and is not limited to the two I2C bus design described above. Furthermore, the present invention may be used with a variety on low-speed peripheral devices, and is not limited to the lightstrip embodiment as described above.

While the principles of the disclosure have been illustrated in relation to the exemplary embodiments shown herein, the principles of the disclosure are not limited thereto and include any modification, variation or permutation thereof.

What is claimed is:

1. A method for controlling low-speed peripheral devices, comprising:
connecting a first I2C control unit to a microcontroller for an LED;
connecting a second I2C control unit to the microcontroller for the LED;
setting a first I2C control unit as a master control unit for the microcontroller;
setting a second I2C control unit as a slave control unit for the microcontroller;
setting an I2C bus switch to read a first I2C bus path from the first I2C control unit;
monitoring the first I2C control unit for a failure;
setting the second I2C control unit as the master control unit when the failure occurs;
re-booting the first I2C control unit;
setting the first I2C control unit as the slave control unit;
monitoring the second I2C control unit for a failure;
switching an I2C bus switch to read a second I2C bus path from the second I2C control unit; and
switching the LED on and off using the microcontroller.
